(19) United States
(12) Patent Application Publication
(10) Pub. No.: US 2026/0211498 A1
(43) Pub. Date: Jul. 23, 2026

(54) A Bio-Activity Monitoring Wearable, System and Uses

(71) Applicant: National University of Singapore, Singapore (SG)

(72) Inventors: Teck Lun GOH, Singapore (SG); Li-Shiuan PEH, Singapore (SG)

(21) Appl. No.: 19/140,637

(22) PCT Filed: Dec. 18, 2023
(86) PCT No.: PCT/SG2023/050845

§ 371 Date: Jun. 18, 2025

(30) Foreign Application Priority Data
Dec. 19, 2022 (SG) 10202260494S

(51) Int. Cl. G06F 3/01

(52) U.S. Cl. CPC G06F 3/015

(57) ABSTRACT

The invention provides bio-activity monitoring wearable (1), comprising a wearable device (11) and at least one bio-information acquisition device (12a,12b) attached to the wearable device (11). The bio-information acquisition device (12a, 12b) is in conformal contact with a user as the wearable is worn by the user. The bio-information acquisition device (12,12b) further comprises an electronic board (121) that is pliable and a plurality of projections (122) that are elastic. The projections (122), configured as spring-loaded pins as an example, are in contact with the skin of the user, as the wearable device (11) is worn by the user, even as the user is in motion. Further described includes its system and method of use.

### RELATED APPLICATIONS

The present application is a national phase application of PCT/SG2023/050845 and claims priority to Singapore patent application Ser. No. 10202260494S filed on 19 Dec. 2023, the disclosure of which is incorporated in its entirety. Also incorporated by reference are 4 prior art documents that are identified in the following description.

### FIELD OF INVENTION

The invention relates to a bio-activity monitoring wearable. More specifically, the invention relates to a wearable cap that is head-worn, which monitors biosignals of a user in real-time, together with its system and method of use.

### BACKGROUND OF THE INVENTION

Electroencephalography (EEG) is a non-invasive technology that allows the electrocortical activity of a user to be monitored. While this technology has met increased usage in various applications, conventional EEG-related devices are tedious to use as they require a long preparation time for them to be donned and worn by a user, and require the user to remain in a stationary posture during the entire process. Moreover, due to the materials and chemicals used for these devices, they are also confined to a laboratory environment.

Among the prior arts include the work of A. D. Nordin et al., “Dual-electrode motion artifact cancellation for mobile electroencephalography,” which is described in the Journal of Neural Engineering, August 2018. In this prior art, a dual-electrode configuration that removes motion artifact from EEG recording is disclosed. The EEG device of this prior art uses wet electrodes, making it requiring a long preparation time to inject electrolyte gel into each electrode position prior to use. It is also immobile as it is tethered to a station in a laboratory. Moreover, it is obtrusive and not aesthetically pleasing enough to use outside the laboratory.

The prior arts also include the work of Y.-P. Lin et al., “Assessing the feasibility of online SSVEP decoding in human walking using a consumer EEG headset,” which is described the Journal of Neuroengineering and rehabilitation 2014. In this prior art, there is disclosed a 14-channel Emotive EEG device that performs SSVEP experiments while a user is in a walking state. However, the disclosed EEG device is semi-dry, and the user is required to periodically replenish the electrodes with saline solution approximately once every 20 minutes. However, the headset does not perform well at high walking speeds.

The prior arts also include the U.S. Pat. No. 9,927,872, which discloses a wireless BCI input system for mobile intelligent devices. The system includes an SSVEP keyboard for stimulating SSVEP signals and an EEG device in the form of a headband for acquiring EEG signals. The EEG device may include an EEG acquisition module, an EEG analysis module, and a Bluetooth communication module, which are used for acquiring EEG signals, determining the user's input intentions, and sending characters or controlling commands to a matched mobile intelligent device via Bluetooth connection. However, its EEG device may not perform well when the user performs daily routines.

Moreover, while dry electrodes are known in the art, they may fail to perform well when a user is in motion as they are rigid and are unable to maintain perfect contact with the scalp due to the curvature and unevenness of the surface of the scalp. Hence, the usage of rigid shaped electrodes may also lead to inferior signal quality due to a high electrode-scalp impedance.

Accordingly, it is desirable to provide a bio-activity monitoring wearable device capable of monitoring at least the electrocortical activity of the user, which can have its bio-signal acquisition unit be in conformal contact with the user even as the user is in motion.

### SUMMARY OF INVENTION

An objective of the invention is to bio-activity monitoring wearable device capable of monitoring at least the electrocortical activity of the user, which can have its bio-signal acquisition unit be in conformal contact with the user even as the user is in motion. To achieve this objective, the bio-activity monitoring wearable device is made to be a wearable with at least one bio-information acquisition device. The bio-information acquisition device has a pliable electronic board and a plurality of elastic projections that may act as electrodes. With this, the projections may be in contact with the skin of the user, as the wearable device is worn by the user, even as the user is in motion.

Advantageously, the present invention has a short setup time and is dry in that it does not require the use of electrolyte gels. Moreover, it is lightweight, portable, and mobile. Furthermore, it is non-obstructive towards the user by having an unobtrusive form factor, and is aesthetically pleasing.

Advantageously as well, the present invention may not require a conductive cap to be overlaid over the projections acting as electrodes while still retaining the noise removal ability of the electrodes.

Advantageously as well, the bio-activity monitoring wearable may continuously sense a cognitive state of a user as they go about their everyday life. The bio-activity monitoring wearable device provides a quantitative analysis of the cognitive state of the user, providing indications of whether or not the user is in a state of stress, relaxation, likes or dislikes, and various other emotional states. These quantitative analyses may then be used to correlate with the user's current environment and/or interactions with others. This quantitative analysis may be, by way of example, used by medical practitioners to assess their patients on the impact of the administered behavioral intervention therapies for the wellness of their patients. This quantitative analysis may be, by way of example, used by advertisers to fine-tune the advertisements, and/or be used by dating businesses to improve their potential match of their clients.

The present invention intends to provide a bio-activity monitoring wearable, comprising a wearable device and at least one bio-information acquisition device attached to the wearable device. The bio-information acquisition device is to be in conformal contact with a user as the wearable device is worn by the user.

Preferably, the bio-information acquisition device further comprises an electronic board, and a plurality of projections.

Preferably, the plurality of projections forms at least one projection cluster on the electronic board. Preferably as well, the projections in the projection cluster have a comb-like arrangement.

Preferably, the electronic board is pliable. Preferably as well, the electronic board comprises one or more layers that include a noise-ground plane layer.

Preferably, the projections are elastic. Preferably as well, the projections are in contact with skin of the user, as the wearable device is worn by the user, even as the user is in motion. Preferably as well, the projections further comprise a resilient member.

Preferably, the bio-activity monitoring wearable further comprises a conditioning module, a digitization and communication device and a networked device.

Preferably, the networked device operates a cleaning module. Preferably as well, the networked device operates an augmentation module. Preferably as well, the networked device operates a calculation module. Preferably as well, networked device operates a classification module.

Preferably, the classification module classifies inputs into one or more categories across the brain-computer interface paradigm as outputs.

Preferably, the bio-activity monitoring wearable further comprises a conductive strip.

Preferably, regarding the bio-activity monitoring wearable, the wearable device is configured as a cap.

The present invention also provides a system for monitoring bio-activity of a user, comprising a bio-activity monitoring wearable, which includes a wearable device and at least one bio-information acquisition device attached to the wearable device. The system also includes a networked device that is in connection with the bio-activity monitoring wearable. The bio-information acquisition device of the bio-activity monitoring wearable is to be in conformal contact with the user as the wearable is worn by the user.

The present invention also provides a method for capturing EEG bio-activity of a user, comprises: wearing, by a user, a bio-activity monitoring wearable, which comprises a wearable device and at least one bio-information acquisition device attached to the wearable device. The bio-information acquisition device is in conformal contact with the user as the wearable device is worn by the user. A use of this method comprises: tapping on the EEG signal to assess a user's cognitive or emotive state or behavioural response to a stimulus. Another use of this method comprises: tapping on the EEG signal to provide a signal to activate or control an external device or an application.

One skilled in the art will readily appreciate that the invention is well adapted to carry out the objects and obtain the ends and advantages mentioned, as well as those inherent therein. The embodiments described herein are not intended as limitations on the scope of the invention.

### BRIEF DESCRIPTION OF THE DRAWINGS

To facilitate an understanding of the invention, there is illustrated in the accompanying drawings the preferred embodiments, from an inspection of which when considered in connection with the following description, the invention, its construction and operation and many of its advantages would be readily understood and appreciated.

FIG. 1 is a diagram illustrating a side view of the bio-activity monitoring wearable of the present invention, in its preferred embodiment, as it is to be worn by a user.

FIG. 2 is a diagram illustrating a perspective view of the underside of the bio-activity monitoring wearable of the present invention, in its preferred embodiment.

FIG. 3 is a diagram illustrating a back view of the bio-activity monitoring wearable of the present invention, in its preferred embodiment.

FIG. 4 is a diagram illustrating a perspective front view of the bio-activity monitoring wearable of the present invention, in its preferred embodiment.

FIG. 5 is a diagram illustrating a block diagram representation of the bio-activity monitoring wearable 1 of the present invention, further including its hardware and software components, within a system for monitoring the bio-activity of a user.

FIG. 6 is a diagram illustrating a perspective view of the bio-information acquisition device of the bio-activity monitoring wearable of the present invention in its first embodiment.

FIG. 7 is a diagram illustrating a perspective view of the bio-information acquisition device of the bio-activity monitoring wearable of the present invention in its second embodiment.

FIG. 8 is a diagram illustrating a sectional side view of the bio-information acquisition device whereby layers of its electronic board are shown, which may be present in all of its embodiments.

FIG. 9 is a diagram illustrating a sectional side view of the electronic board and the protrusion of the bio-information acquisition device prior to being worn by a user, regardless of its embodiments.

FIG. 10 is a diagram illustrating a sectional side view of the electronic board and the protrusion of the bio-information acquisition device after being worn by a user, regardless of its embodiments.

FIGS. 11 and 12 are diagrams illustrating the preferred contact points of the bio-information acquisition device of the present invention on the user when the bio-activity monitoring wearable is worn by the user.

FIG. 13 illustrates a flowchart that is an example method flow for using the bio-activity monitoring wearable of the present invention by a user.

FIG. 14 illustrates an example experiment procedure for validating the bio-activity monitoring wearable of the present invention.

FIG. 15 illustrates a first experiment data that was collected for validating the performance of the bio-activity monitoring wearable of the present invention.

FIG. 16 illustrates a second experiment data that was collected for validating the performance of the bio-activity monitoring wearable of the present invention.

FIG. 17 illustrates contact impedance of electrodes of the present invention compared with those of known wet and dry electrodes.

FIGS. 18A-18D illustrate comparative alpha rhythm signal captures at the occipital electrode position using the dry electrodes of the present invention against known wet electrodes.

FIGS. 19A-19F illustrate comparative performance of the alpha rhythm signal captures at the occipital electrode position using the dry electrodes of the present invention against known dry electrodes with the participants in a vehicle with engine off.

FIGS. 20A-20F illustrate comparative performance of the alpha rhythm signal captures at the occipital electrode position using the dry electrodes of the present invention against known dry electrodes with the participants in a vehicle with engine turned on to generate noise artifacts.

FIGS. 21-22 illustrate two confusion matrices to elicit EEG occipital responses.

FIG. 23 illustrates brain wave spectrum power in the occipital region in response to a meditation podcast.

### DETAILED DESCRIPTION OF THE INVENTION

The present invention relates to a bio-activity monitoring wearable device that monitors biosignals of a user in real-time even as the user is in motion. The invention may also be presented in a number of different embodiments with common elements.

According to the concept of the present invention, the bio-activity monitoring wearable is a wearable device that has means for acquiring, processing, calculating, and classifying biosignals of a user. It may also communicate with one or more networked devices for providing the biosignals and/or their associated information thereto. Preferably, the bio-activity monitoring wearable device conforms to the head of the user as it is being worn, thereby allowing the bio-activity of the user to be monitored as the user is in motion performing their daily activities.

From hereon, it should be noted that biosignals, in the context of the invention, preferably relate to bio-activities that are periodic or aperiodic in nature, such as bio-mechanical pulses or bio-electrical pulses that occur naturally within living organisms. Preferably, in the context of the invention, the biosignals are signals related to electroencephalography.

From hereon as well, it should be noted that the wearable may refer to articles, accessories, or clothing that at least provides a head-covering functionality. These articles, accessories or clothing may include headwear, headgears or headpieces, which may be, by way of example, caps, sports visors, hats, helmets, beanies, hoods, or the like. These articles, accessories or clothing may also include full-body garments, or partial-body garments that substantially cover a head portion of a user, which may be, by way of example, full-body swimsuits, hoodies, or the like. Preferably, the wearable of the present invention is a cap. However, it is to be noted that its descriptions shall similarly be applicable to the aforementioned articles, accessories, or clothing.

The invention will now be described in greater detail, by way of example, with reference to the figures. For ease of reference, common reference numerals or series of numerals will be used throughout the figures when referring to the same or similar features common to the figures.

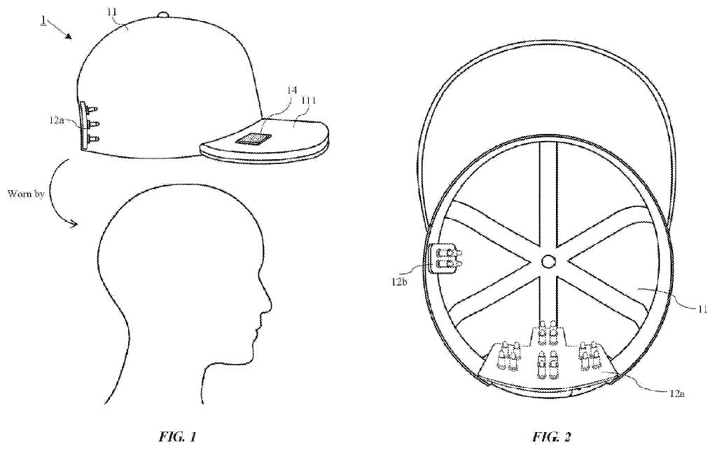

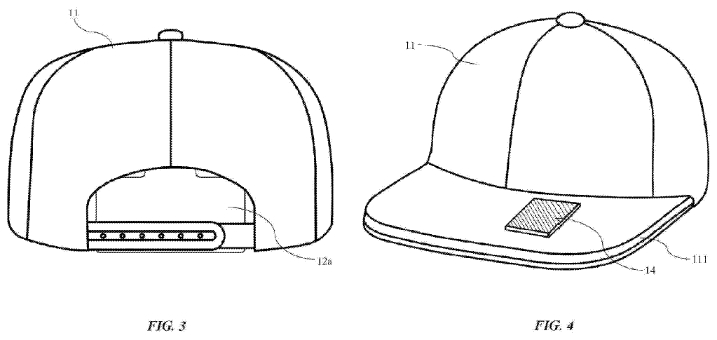

FIG. 1 illustrates a side view of the bio-activity monitoring wearable 1 of the present invention as it is to be worn by a user. Whereas, FIGS. 2 to 4 illustrate one or more views of the bio-activity monitoring wearable 1. In particular, FIG. 2 illustrates a perspective view of the underside of the bio-activity monitoring wearable 1, FIG. 3 illustrates a rear view of the bio-activity monitoring wearable 1, and FIG. 4 illustrates a perspective front view of the bio-activity monitoring wearable 1.

As shown in FIGS. 1 to 4, the bio-activity monitoring wearable 1 comprises a wearable device 11, which is preferably a head-worn wearable, more specifically, a cap. Further shown is that there are one or more devices integrated with the wearable device 11. These devices may include a bio-information acquisition device 12a of a first embodiment, a bio-information acquisition device 12b of a second embodiment and a digitization and communication device 14.

Whilst not shown, the devices 12a, 12b, 14 are preferably securely attached to the wearable device 11 through sewing. Alternatively, they may be securely attached to the wearable device 11 through fastening means, such as hook-and-loop fasteners (VELCRO®), pin fasteners such as butterfly clutches, magnetic clasps, screws and nuts, or the like.

Whilst not shown as well, connectivity between each device 12a, 12b, 14 may be established through wired connection means such as reinforced wires, conductive fibres, conductive strips, or the like. For improving the reliability of each device 12a, 12b, 14, the wired connection means may further include stiffeners on their underside. Connectivity between each device 12a, 12b, 14 may also be established through direct connection when fabricated into a single integrated device.

As shown in FIGS. 1 and 2, the bio-information acquisition devices 12a, 12b are preferably adjacent to inward-facing areas of the wearable device 11. The inward-facing areas of the wearable 11 may more specifically refer to areas that become in contact with the head of the user when the wearable device 11 is worn by the user. FIGS. 1 and 2 show that both bio-information acquisition devices 12a, 12b are positionally along the inward-facing areas of the wearable device 11 for it to correspondingly be in contact with regions of the head of the user when the wearable device 11 is worn by the user. Alternatively, the bio-information acquisition devices 12a, 12b may be positioned along the inward-facing areas of the wearable device 11 for them to each be correspondingly be in contact with any one or a combination of the occipital regions, the frontal regions, the parietal regions, and temporal areas of the head of the user when the wearable device 11 is worn by the user. Each bio-information acquisition device 12a, 12b may be placed together or away from each other if so desired.

As shown in FIGS. 1 and 4, the digitization and communication device 14 is preferably located within the wearable device 11. More specifically, it is substantially between the fabric layers of the wearable device 11. As per FIGS. 1 and 4, the digitization and communication device 14 is positioned at the visor or bill regions of the wearable device 11. The digitization and communication device 14 may first be disposed along and/or within the visor or bill of the wearable device 11, with a piece of supplementary fabric 111 sewn over the visor or bill of the wearable device 11 to cover and enclose the digitization and communication device 14 therewithin. Preferably, the supplementary fabric 111 is waterproof, and may protect the digitization and communication device 14 from the external environment.

Outward-facing areas of the wearable device 11 may refer to areas that are away from contact with the head of the user when the wearable device 11 is worn by the user. It should be noted that the placement of the digitization and communication device 14 along the wearable device 11 may not be limited to as shown in FIGS. 1, 3 and 4. Alternatively, the digitization and communication device 14 may be adjacent to outward-facing areas of the wearable device 11. Alternatively as well, the digitization and communication device 14 may be located within the wearable device 11 by use of one or more supplementary fabric layers to cover and enclose them within the wearable device 11 at various positions.

Whilst not shown, the bio-activity monitoring wearable 1 further includes a ground electrode located at the inward-facing walls of the wearable device 11. Preferably, the ground electrode is placed about the wearable device 11 so that it may preferably be in contact with the forehead of the user when the bio-activity monitoring wearable 1 is worn. In the case where the wearable device 11 is in the form of a cap, the ground electrode is positioned as its sweatband. The ground electrode may be a fabric conductive tape, preferably being Part Number: 46W5E03020.NN00 obtained from Laird Technologies, and it may be directly connected to the digitization and communication device 14.

FIG. 5 illustrates a block diagram representation of the bio-activity monitoring wearable 1 of the present invention, further including its hardware and software components, within a system for monitoring bio-activity of a user. As shown, the bio-activity monitoring wearable 1 comprises the wearable device 11, the bio-information acquisition device 12a, 12b, a conditioning module 131, and the digitization and communication device 14, and the bio-activity monitoring wearable 1 is to be in communication with a networked device 2.

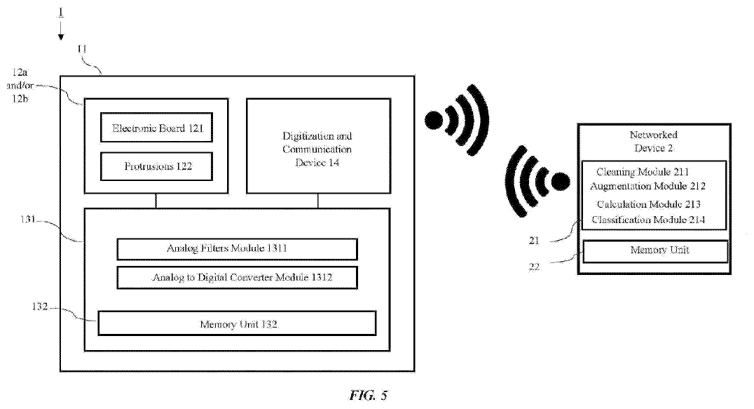

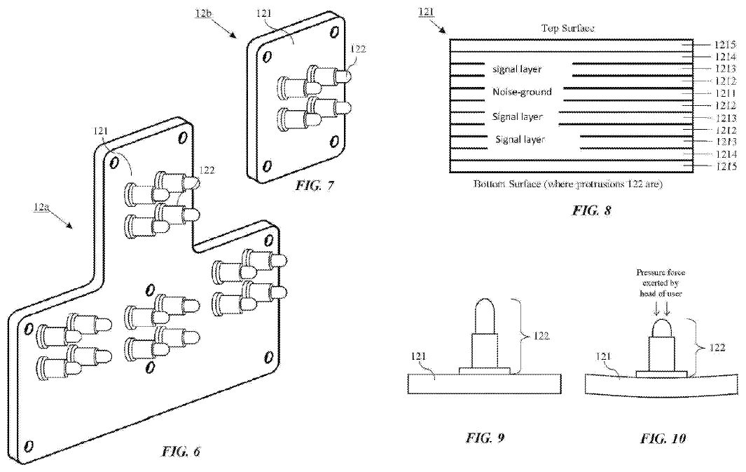

As shown in FIG. 5, the bio-information acquisition devices 12a, 12b further comprise an electronic board 121 and protrusions 122. More specifically, each bio-information acquisition device 12a, 12b is an electronic board 121 with a plurality of protrusions 122 that are preferably electrodes. The bio-information acquisition devices 12a, 12b are to be further detailed when FIGS. 6 to 12 are described. In general, the bio-information acquisition devices 12a, 12b may be used for, or contribute, to the monitoring of bio-information such as biosignals from the user, through the protrusions 122 and the electronic board 121. The protrusions 122 may be used to correspondingly establish one or more channels for waveforms of the biosignals to be provided to the digitization and communication device 14.

As shown in FIG. 5, the wearable device 11 further comprises one or more hardware components such as the conditioning module 131 and a memory unit 132. The conditioning module 131 further includes an analog filter module 1311 and an analog to digital converter module 1312. The networked device 2 is to receive biosignals of the user, after being sent wirelessly from the digitization and communication device 14. The networked device 2 further includes an application software 21 for operating one or more software modules that include a cleaning module 211, an augmentation module 212, a calculation module 213 and a classification module 214 and perform any one or a combination of cleaning, augmentation, calculation, and classification thereupon. The networked device 2 may include a memory unit 22 to run the application software 21.

The wearable device 1 may further include a processor to control signals from the bio-information acquisition device 12a, 12b to the conditioning module 131, memory unit 132 and the digitization and communication device 14; preferably, the processor is a conventional processor, application-specific integrated circuit (ASIC), a field-programmable gate array (FPGA), or a combination thereof.

Regarding the memory unit 132, it further comprises one or more non-volatile memory units, one or more volatile memory units, or a combination thereof. The non-volatile memory unit may store program files related to the application software, while the volatile memory unit may temporarily store processing data during runtime of the application software. The non-volatile memory unit may be, but will not be limited to, secure digital (SD) cards, TransFlash (TF) cards, or the like. The volatile memory unit may be, but will not be limited to, dynamic random access memory (DRAM), static dynamic random access memory (SRAM) and their synchronous variants, or the like.

Preferably, the digitization and communication device 14 is a derivative of an 8-channel g. NAUTILUS Multipurpose obtainable from G.Tec Medical Engineering GmbH. This is because the digitization and communication device 14 is to at least have common components found in such conventional bio-activity monitoring devices. Alternatively, the digitization and communication device 14 may be a derivative of LiveAmp obtainable from Brain Products GmbH, SMARTING Mobi obtained from mBraintrain, Cyton Board obtained from OpenBCI, or the like. Otherwise, the digitization and communication device 14 may be in the form of a single-board computer, a single-board microcontroller, a chip-on-board, or the like.

As shown in FIG. 5, the conditioning module 131 includes one or more filters and/or analogue to digital converters for digitising the biosignals acquired by the bio-information acquisition devices 12a, 12b. By way of example, it may further include band-pass filters that are tailored to range from about 5 Hz to about 30 Hz, as this range includes the full spectral range of the SSVEP stimuli up to their 3rd harmonics and also filters out other frequency bands that are not of interest. By way of example, it may also further include notch filters that are tailored to range from about 48 Hz to about 52 Hz to remove line noise of 50 Hz.

Furthermore, it is noted that the sampling rate of the digitization and communication device 14 for digitising the biosignals is preferably tailored to be about 250 Hz. However, it may be of any other suitable sampling rate.

Preferably, the digitization and communication device 14 may be configured to accept one or more channels. Most preferably, the digitization and communication device 14 accepts at least four signal channels that are from the bio-information acquisition device of the first embodiment 12a for obtaining biosignals of the user, which are designated as the biosignal channels 1 to 4.

Most preferably as well, the digitization and communication device 14 may further accept a signal channel that is from a noise-ground plane of either one of the bio-information acquisition devices 12a, 12b acting as a noise electrode, which is designated as a noise electrode channel.

Most preferably as well, the digitization and communication device 14 may further accept a signal channel from the bio-information acquisition device of the second embodiment 12b for obtaining biosignals of the user, which is designated as a reference electrode channel.

Most preferably as well, the digitization and communication device 14 may further accept a signal channel that is a signal picked up by the ground electrode that is in contact with the skin of the user, which is designated as a ground electrode channel.

The digitization and communication device 14 is preferably a device suitable for near-range communication for establishing and facilitating an exchange of information between the bio-activity monitoring wearable 1 and the networked device 2. The digitization and communication device 14 may have a transceiver or an antenna circuitry for it to perform communication. Communication with the networked device 2 may be performed preferably through conventional communication protocols that conserve power while having appreciable data rates. The communication protocols employed may be, by way of example, include Bluetooth Low Energy (BLE), Zigbee, or the like.

The networked device 2 is preferably a conventional end-user device such as a smartphone, tablet, personal digital assistant (PDA), laptop or desktop, where the biosignals and/or their associated information received from the digitization and communication device 14 may be stored there and displayed thereon. It may also refer to one or more gateway devices that are in communication with a network that includes a server and/or a database, whereby biosignals and/or their associated information received from the digitization and communication device 14 may be stored on them. The server and/or database, may be, by way of example, proprietarily owned by a medical institution in which the user is a patient of, whereby a medical practitioner assigned to the user may freely reference data from the bio-activity monitoring wearable 1 to evaluate a historical bio-activity of the user.

Whilst not shown in FIGS. 1 to 5, the bio-activity monitoring wearable 1 may further include a power source that supplies power to any one or a combination of the bio-information acquisition devices 12a, 12b, the conditioning module 131, memory unit 132, and the digitization and communication device 14. With this, a user may freely switch the bio-activity monitoring wearable 1 on or off. The power source is preferably of a small form factor, and it may be attached to the wearable device 11 similarly to the digitization and communication device 14. The power source may be, but shall not be limited to, rechargeable power sources such as lithium-ion battery packs, solar cells, or the like, or non-rechargeable power sources such as electrolyte-based batteries, or the like.

From hereon, the bio-information acquisition devices 12a, 12b will now be further described with reference to FIGS. 6 to 12.

FIG. 6 illustrates a perspective view of the bio-information acquisition device in its first embodiment 12a. Shown in this figure are its electronic board 121 and its plurality of projections 122. Preferably, for the bio-information acquisition device 12a to flexibly conform to the head of the user and penetrate the hair layer to be in conformal contact with the user in a constant manner, more specifically, the skin of the user, even more specifically, the scalp of the user. As such, its electronic board 121 is made to at least be pliable, and its projections 122 are each made to at least be elastic.

In regards to the bio-information acquisition device in its first embodiment 12a, its electronic board 121 may include a noise electrode. Its protrusions 122 may be used for a multi-electrode configuration-based monitoring of bioactivity. Its protrusions 122 may also be used to establish a reference electrode if so desired.

FIG. 7 illustrates a perspective view of the bio-information acquisition device in its second embodiment 12b. It is to be substantially similar to the bio-information acquisition device of the first embodiment 12a, but having a smaller electronic board 121 and fewer protrusions 122. Whilst the following descriptions may focus on the bio-information acquisition device in its first embodiment 12a, it is to be noted that they may be applicable to the bio-information acquisition device in its second embodiment 12b.

In regards to the bio-information acquisition device in its second embodiment 12b, its electronic board 121 may include a noise electrode. Its protrusions 122 may be used for a single-electrode configuration-based monitoring of bioactivity. Its protrusions 122 may also be used to establish a reference electrode if so desired.

Preferably, the bio-information acquisition devices 12a, 12b, regardless of its embodiments, are to have a small and modular form factor for them to be concealed by wearable device 11 while still being able to be freely positioned within the wearable device 11.

FIG. 8 is a diagram illustrating a sectional side view of the bio-information acquisition devices 12a, 12b in which the layers of their electronic boards 121 are shown. Preferably, the electronic board 121 has one or more layers that form a circuit, and these layers may comprise any one or combination of a first layer-type 1211 that is a noise-ground plane layer, a second layer-type 1213 that is a signal-routing layer, a third layer-type 1212 that is a dielectric layer, a fourth layer-type 1214 that is a solder layer, and a fifth layer-type 1215 that is a film overlay layer. Preferably, the electronic board 121 is a printed circuit board. Whilst not shown, there may be one or more vias for facilitating signal routing.

In comparison with bio-information acquisition devices of conventional bio-activity monitoring devices (e.g. electroencephalogram wet electrode devices), the first layer-type 1211 intends to emulate the overlaid conductive cap in which electrodes are placed and act as a noise electrode. Eventually, signals that are present in the first layer-type 1211 may be tapped out from the electronic board 121 to be used as a noise electrode channel by the digitization and communication device 14.

In comparison with bio-information acquisition devices of conventional bio-activity monitoring wearables, the second layer-type 1213 intends to emulate their signal routing wires which are connected to their electrodes. In this case, the second layer-type 1213 provides signal routing to the signals sensed by the protrusions 122 so that they may eventually reach the digitization and communication device 14.

The third layer-type 1212 is to electrically isolate the first layer-type 1211 and the second layer-type 1213 from each other. The third layer-type 1212 also electrically isolate the second layer-type 1213 from another second layer-type 1213.

The fourth layer-type (or solder) 1214 and the fifth layer-type (or overlay) 1215 are conventional layers present within an electronic board known to a person skilled in the art.

As shown in FIG. 8 the layers of the electronic board 121 are preferably laminated in a sequential order, from bottom to top, in which there is a first layer (ie. overlay) being of the fifth layer-type 1215, a second layer (ie. solder) being of the fourth layer-type 1214, a third layer (ie. top signal) being of a second layer-type 1213, a fourth layer (ie. dielectric) being of a third layer-type 1212, a fifth layer (ie. noise-ground plane) being of a first layer type 1211, a sixth layer (ie. dielectric) being of a third layer type 1212, a seventh layer (or signal) being of a second layer-type 1213, an eighth layer (ie, dielectric) being of a third layer type 1212, a ninth layer (ie. signal) being of a second layer-type 1213, a tenth layer (ie. solder) being of a fourth layer-type 1214, and an eleventh layer (ie. overlay) being of a fifth layer-type 1215.

FIGS. 9 and 10 are diagrams illustrating the changes in the shape of the bio-information acquisition devices 12a, 12b as the bio-activity monitoring wearable 1 is worn by a user. In particular, FIG. 8 illustrates a sectional side view of the electronic board 121 and the protrusion 122 of the bio-information acquisition device 12a,12b prior to being worn by a user, while FIG. 9 is a diagram illustrating a sectional side view of the electronic board 121 and the protrusion 122 of the bio-information acquisition device 12a,12b after being worn by a user.

Preferably, prior to being worn by a user, the bio-information acquisition device 12a,12b has its electronic board 121 in a flat state and its protrusion 122 in its original state with its vertical length remaining intact as shown in FIG. 9. After being worn by a user, the bio-information acquisition device 12a,12b has its electronic board 121 being substantially pliable assumes a curved state with downward curvature with respect to the pressure force exerted onto it by the head of the user, and its protrusion 122 being substantially elastic may assume a compressed state with its length reduced as shown in FIG. 10 but with its tip preferably in contact with the head of the user. It is to be noted after the user takes off the wearable device 11, the bio-information acquisition device 12 may return to the state as shown in FIG. 9.

It is to be noted that, if so desired, the electronic board 121 may also assume a curved state with upward curvature with respect to the pressure force exerted onto it.

For the electronic board 121 to be substantially pliable for it to act as per FIGS. 9 and 10, it is preferably made from a flexible substrate, which may be, by way of example, polyimide. Moreover, the deformation of the electronic board 121 is non-permanent or semi-permanent. In the case where its deformation is semi-permanent, it may retain its deformed shape for repeated conformal use by the user until it experiences forces that shape it.

For the protrusions 122 to be substantially elastic for them to act as per FIGS. 9 and 10, it is preferable made with a built-in resilient member. Such a resilient member may be, by way of example a spring, a rubber-like support, hydraulics, or any other form of compressible or retractable material that is integrable within the protrusions 122. Alternatively, the protrusions 122 may be made to be telescopically retractable in an elastic manner.

Whilst not shown, either one or both the electronic board 121 or the protrusions 122 may have stiffeners to increase their resistance to deformation or compression, if necessary.

Preferably, the protrusions 122 are electrodes, which are metal contacts that have the sensitivity to detect electric potential activity within the head of the user. Preferably as well, the protrusions 122 are dry, and as such, they do not require intermediary fluid such as electrolyte gel for improving sensitivity and conductivity of the protrusions much like in bio-information acquisition devices of conventional bio-activity monitoring devices.

Preferably, the protrusions or electrodes 122 are cylindrical structures with a rounded end that is to be in a comfortable contact with the skin of the user, more specifically, the scalp of the head of the user. Preferably as well, the protrusions/electrodes 122 are of an appropriate length so as to not obstruct the size of the wearable device 11 as it is worn by the user. The length of the protrusion/electrode 122 is to also be of a length that penetrates the hair layer to be in contact with the scalp of the head of the user. The presence of a resilient member within the protrusion/electrode 122 further allows the protrusion/electrode 122 to be in constant contact with the scalp of the user regardless of the curvature or the unevenness of the head of the user. Hence, the contact efficiencies of the electrode-scalp interface are improved, thereby reducing and/or minimising fluctuations in the electrode-scalp impedance. This impedance is to remain substantially unchanged so long the maximum stroke of the protrusion/electrode 122 is not exceeded, thereby also reducing induced noise due to motion artifacts as the user is in motion.

Most preferably, the protrusions/electrodes 122 are surface mount spring-loaded pins (part number: 0871-0-57-20-82-14-11-0) obtainable from Mill-Max Manufacturing Corporation.

In particular, the protrusions/electrodes 122 are distributed across the electronic board 121 in a clustered manner. With this, there may be one or more protrusion clusters across the electronic board 121. In particular, within each cluster, the protrusions/electrodes 122 are arranged into a comb-like arrangement with each of them acting as a finger of a comb. Moreover, each cluster may have an even number of protrusions/electrodes 122 (most preferably 4) forming a quadrilateral outline. By way of example, the bio-information acquisition device of the first embodiment 12a has four protrusion clusters distributed across its electronic board 121, whereas the bio-information acquisition device 12b of the second embodiment has only one protrusion cluster distributed across its electronic board 121. It is to be noted that the arrangement of the protrusions/electrodes 122 within a cluster, the number of protrusions/electrodes 122 in the cluster, and the outline of the cluster may be of any other arrangement, number or outline. It is to be noted that each protrusion cluster may correspond to a channel.

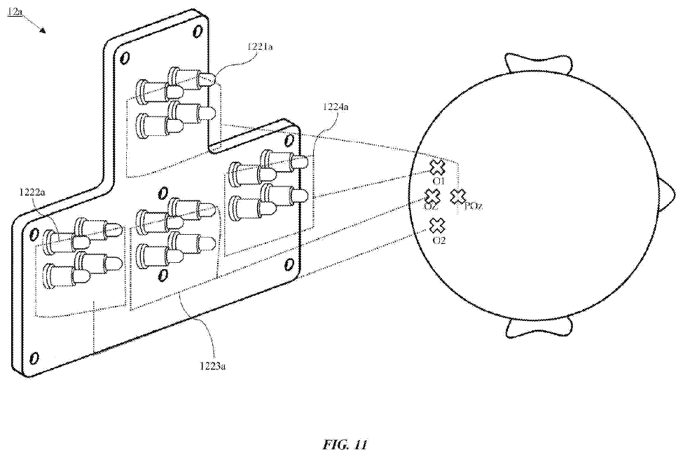

FIG. 11 is a diagram illustrating the preferred contact points of each protrusion cluster of the bio-information acquisition device 12a of the first embodiment on the user when the bio-activity monitoring wearable 1 is worn by the user. Preferably, the contact points by each protrusion cluster of the bio-information acquisition device 12a of the first embodiment may follow the International 10-20 System. By way of example, when the bio-activity monitoring wearable 1 is worn, there is a first protrusion cluster 1221a that is to be substantially be in contact with the parietal occipital midline region (POz region) of the head of the user, a second protrusion cluster 1222a that is be substantially be in contact with a left occipital region (O1 Region) of the head of the user, a third protrusion cluster 1223a that is to substantially be in contact with the midline occipital region (OZ region) of the head of the user, and a fourth protrusion cluster 1224a that is be substantially be in contact with a right occipital region (O2 Region) of the head of the user.

Preferably, the electronic board 121 of the bio-information acquisition device 12a of the first embodiment may be moulded into a specific shape to facilitate the contact of the aforementioned protrusion clusters 1221a, 1222a, 1223a, 1224a onto their specific regions on the head of a user. More specifically, the electronic board 121 may have the shape of an inverted “T”. Alternatively, it may have an “H”-like shape, a “V”-like shape, or any other shape that may allow the protrusion clusters 1221a, 1222a, 1223a, 1224a to reach desired locations on the head of the user.

It should be noted as well that the contact locations of the bio-information acquisition devices 12a, 12b on the user may change depending on the orientation of the wearable device 11. By way of example as per the bio-activity monitoring wearable 1 as described in FIGS. 1 to 11, the bio-information acquisition device 12a of the first embodiment is preferably in contact with the occipital region of the head, however, it may be made to be in contact with the parietal region, the frontal region, or the temporal region of the head of the user through rotation of the wearable device 11, or through its direct detachment and reattachment, for collecting biosignals from these regions.

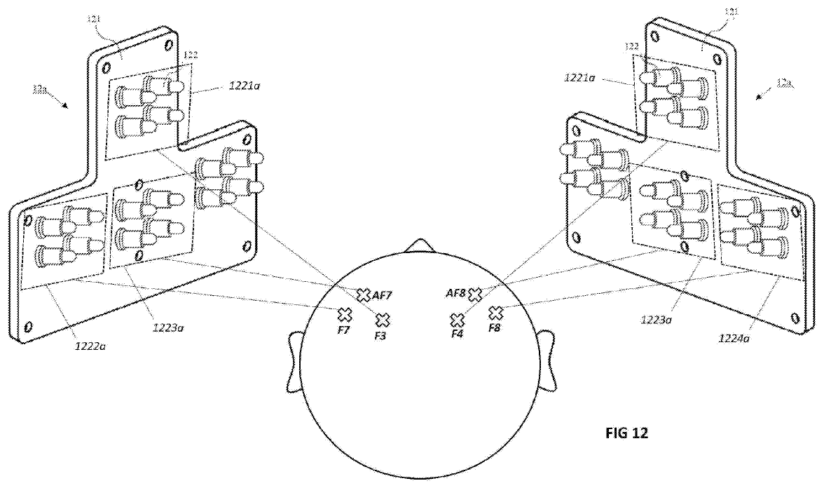

It should be noted as well that the bio-activity monitoring wearable 1 may be configured to have more than one bio-information acquisition device 12a of the first embodiment distributed across the wearable device 11 for an increased contact coverage with the user. In another configuration, a first bio-information acquisition device of the first embodiment having its protrusions/electrodes 122 in contact with, as per the International 10-20 System, a first right frontal region (F4 region), a second right frontal region (F8 region), and a first intermediate region that is between the right pre-frontal region and the right frontal region (AF8 region), as illustrated in FIG. 12. There is also be a second bio-information acquisition device of the first embodiment having its electrodes 122 in contact with, as per the International 10-20 System, a first left frontal region (F3 region), a second left frontal region (F7 region), and a left intermediate region that is between the left pre-frontal region and the left frontal region (AF7 region). Validations of the bioinformation acquisition device 12,12a of the present invention will be described with reference to FIGS. 14-16.

As for the bio-information acquisition device of the second embodiment 12b, by way of example as per the wearable as described in FIGS. 1 to 12, preferably in contact with the frontal region of the head, most preferably a right temporal region (T4 region as per the International 10-20 System). However, it may be made to be in contact with the parietal region, the occipital region, or the temporal region of the head of the user through rotation of the wearable device 11, or through its direct detachment and reattachment, for collecting biosignals from these regions. Its contact on these regions may be as per the International 10-20 System as well. Moreover, it is to be noted that the bio-activity monitoring wearable 1 may be configured to have more than one bio-information acquisition device of the second embodiment 12b distributed across the wearable device 11 for increased contact coverage with the user.

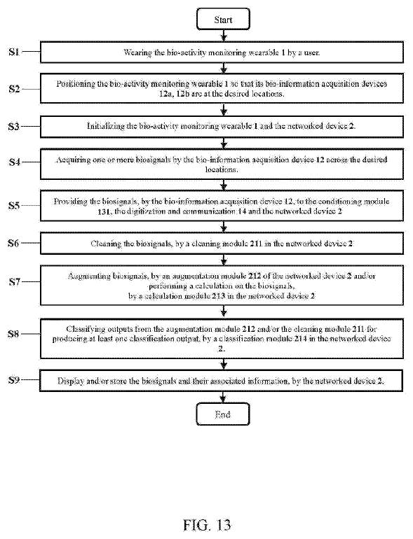

FIG. 13 illustrates a flowchart that is an example method flow describing the usage of the bio-activity monitoring wearable 1 of the present invention by a user for monitoring the bio-activity of a user. It is noted that the steps described in this flowchart are to be interpreted as non-limiting, and minor modifications to the steps (e.g. additions, omissions, or swaps) are permissible by a skilled person without substantial deviation from as described.

The first step is Step S1, which is the step of wearing the bio-activity monitoring wearable 1, by a user.

The next step is Step S2, which is the step of positioning the bio-activity monitoring wearable 1 so that the bio-information acquisition devices 12a, 12b, are in conformal contact at the desired locations, preferably as per FIG. 10. It is also preferable that the ground electrode is in contact with the user as well.

The next step is Step S3, which is the step of initialising the bio-activity monitoring wearable 1 for it to begin its intended operation and the networked device 2. This may be done by switching on the power source of the bio-activity monitoring wearable 1. Preferably, in this step, a connection between the bio-activity monitoring wearable 1 and the networked device 2 is established.

The next step is Step S4, which is the step of acquiring one or more biosignals by the bio-information acquisition devices 12a, 12b across the desired locations.

The next step is Step S5, which is the step of providing the bio-signals, by the bio-information acquisition devices 12a, 12b, to conditioning module 131, the digitization and communication device 14, and the networked device 2. This is preferably done in real-time.

The next step is Step S6, which is the step of cleaning the biosignals, by the cleaning module 211 located in the networked device 2.

The next step is Step S7, which is the step of augmenting the cleaned biosignals, by an augmentation module 212, and/or the step of performing a calculation onto the biosignals, by the calculation module 213 located in the networked device 2. These modules 212, 213 may produce one or more outputs.

The next step is step S8, which is the step of classifying the outputs from the augmentation module 212 and/or calculation module 213 for producing a classification output, by the classification module 214.

The final step may be step S9, which is the step of displaying and/or storing biosignals and/or their associated information that may include one or more classification outputs, by the networked device 2, for it to be referenced by the user in real-time or in the future.

From hereon, the cleaning module 211, the augmentation module 212, the calculation module 213, and the classification module 214 are to be described in detail.

The cleaning module 211 is to process the biosignals wirelessly transmitted by the digitization and communication device 14 into a noise-free or clean signals with minimal artifacts, preferably in real-time. The cleaning module 211 may perform one or more statistical procedures or algorithms, such as Artifact Components Removal (ASR) algorithms.

By way of example, the cleaning module 211 may be configured to clean the biosignals acquired by digitization and communication device 14 by screening the correlations and the amplitudes of the channels. This allows the removal of corrupted channels and/or noisy channels.

More specifically, the cleaning module 211 may perform one or more steps. There may be a first step of determining at least one correlation value from one or more channels. Preferably, the correlation value corresponds to the similarity between the acquired signals of each channel.

The cleaning module 211 may also perform a second step of determining the root mean square (RMS) amplitude of the acquired signals of each channel. Preferably, the RMS amplitude corresponds to the noise present in the signal.

The cleaning module 211 may also perform a third step of comparing the correlation value with a first threshold and a fourth step of comparing RMS amplitude with a second threshold. The first threshold is preferably a value of about 0.75, and the second threshold is preferably a value of about 21u V.

The cleaning module 211 may also perform a fifth step of determining whether or not the signals have properties that exceed the first threshold and the second threshold. Should this be the case, the signal is to be retained for use by the succeeding modules. Should this not be the case, the signal is flagged and removed from use by the succeeding modules. Exceedance of the first threshold signifies that there is a high similarity between signals, whereas exceedance of the second threshold signifies that there is a large amount of noise in the signal.

The augmentation module 212 is to be provided with the cleaned biosignals from the cleaning module 211 so that it performs data augmentation thereupon so that the biosignals may be properly formatted for the classification module 214. The augmentation module may perform one or more procedures or algorithms for doing so.

By way of example, the augmentation module 212 may be configured to downsample, truncate, and augment the biosignals acquired by the digitization and communication device 14 by capturing significant portions within the data of the biosignals. This allows emphasis on the significant portions within data of the biosignals for the classification module 214.

More specifically, the augmentation module 212 may perform one or more steps. There may be a first step of downsampling the cleaned biosignals so that it becomes lightweight to reduce their imposed processing load. Preferably, the biosignals may be downsampled from being of about 250 Hz to be of about 62.5 Hz.

The augmentation module 212 may also perform a second step of truncating the biosignal so that only significant portions of it are retained. Preferably, the biosignal is temporally truncated at its beginning portion and its end portion, as these portions may correspond to transients that were captured before and after the actual biosignal is acquired by the bio-information acquisition device 12a,12b. As an example, a biosignal having a temporal timeframe of 7 s is truncated at its first 1.5 seconds (corresponding to the beginning portion) and its last 0.5 seconds (corresponding to the end portion). These truncated portions are to be discarded and not be used in the succeeding steps. Only the remaining intermediate portion of the biosignal is to be used in the succeeding steps.

The augmentation module 212 may also perform a third step of augmenting the biosignals so that a slightly larger amount of data may be available for the classification module 214. Preferably, the remaining intermediate portion of the biosignal is put under a sliding window of a predetermined timeframe so that it is augmented. Most preferably, the sliding window has a predetermined timeframe of about 3s, and substantially overlaps the waveform data of the biosignal by about 98.5%. With this, the augmented biosignal is outputted to the classification module 214 for its classification.

The calculation module 213 may also concurrently be provided with the cleaned biosignals from the cleaning module 211 so that it does one or more calculations thereupon so that that information derived from the biosignals may be used by the classification module 214. For it to do so, the calculation module 213 may perform one or more procedures or algorithms.

By way of example, the calculation module 213 may be configured to perform frequency domain transformations, derive at least one index that is related to the biosignals, or one ratio that is related to the biosignals, and log either one or both of them over time. The aforementioned index or ratio is most preferably the frontal alpha asymmetry (FAA) index or ratio.

More specifically, the calculation module 213 may perform one or more steps. There may be a first step of transforming the cleaned biosignals from the time domain to the frequency domain by use of a Fast Fourier Transform (FFT) so that the power spectra of the biosignals are obtained. Preferably, within this step, the power spectra may be filtered so that the alpha band is retained, which is preferably the spectra between about 8 Hz to about 12 Hz. Furthermore, the power spectra may be corrected with the power spectrum from the noise electrode channel.

The calculation module 213 may also perform a second step of deriving at least one index or ratio that is related to the biosignals based on its power spectra, with the index or ratio most preferably related to FAA. This derivation may be based on a prior art, more specifically, from L. Sun et al., “Frontal alpha asymmetry, a potential biomarker for the effect of neuromodulation on brain's affective circuitry preliminary evidence from a deep brain stimulation study,” Frontiers in Human Neuroscience, vol. 11, no. 584, December 2017.

Finally, the calculation module 213 may also perform a third step of logging the indexes or ratios over time. These may then be outputted and passed on to the classification module 214.

The classification module 214 is to be provided with either one or both the augmented biosignals from the augmentation module 212, and the indexes or ratios from the calculation module 213, for it to perform classification thereupon.

In a first embodiment of the classification module 214, a trained machine learning model is deployed for performing the classification of the biosignals. The trained machine learning model is most preferably a convolutional neural network (CNN) based on EEGNet (https://github.com/aliasvishnu/EEGNet). Model training had been done in an offline manner prior to deployment, and it is capable of substantially carrying out classification in real-time. The classification module 214 may also use any other machine learning-based classification models such as artificial neural networks (ANN), support vector machine (SVM), or the like. In particular, the machine learning model of the classification module 214 may have the following hyperparameters: an F1 score of about 12, a dimensionality of 2, an F2 measure of about 24, a kernel size of 16×16 (or a kernel length of about 256), and a dropout of about 0.25. Most preferably, the classification module 214 of the first embodiment is to perform a first mode of classification for classifying biosignals across one or more brain-computer interface (BCI) paradigms into one or more categories, which may include steady-state visually evoked potential (SSVEP) category, P300, error-related negativity responses (ERN) category, movement-related cortical potentials (MRCP) category, sensory-motor rhythms (SMR) category, or the like. It is to be noted that the first embodiment of the classification module 214 is to receive outputs from the augmentation module 212 as its inputs, and outputs any one of the aforementioned categories.

In a second embodiment of the classification module 214, the classification module may not use machine learning, and may instead use a rule-based classifier, or the like. Such a rule-based classifier may be a classification of the cognitive states of the user based on properties of the biosignal, such as the value of the indexes or ratios, the gradient of the indexes or ratios, or the like. These states of emotion may include a positive cognitive state or a negative cognitive state. Most preferably, the classification module 214 of the second embodiment is to perform a second mode of classification for classifying biosignals related to FAA. It is to be noted that the second embodiment of the classification module 214 is to receive outputs from the calculation module 213 as its inputs, and outputs any one of the aforementioned cognitive states.

It is to be noted that the classification module 214 may be configured to operate in either one or both of the aforementioned modes of classification depending on the intended use case of the bio-activity monitoring wearable 1.

It is to be noted as well that while the modules 211,212,213,214 presented are of a software embodiment, it should be noted that the presented modules need not be in such a software embodiment, and may be a hardware embodiment where they are connected to a processor or they are their own independent computer system. Ancillary modules may be included to provide support for the aforementioned modules.

It is to be noted as well that networked device 2 may be configured to react to the classification outputs received from the bio-activity monitoring wearable 1. By way of example, the networked device 2 may include a display and its own application software having a graphic user interface (GUI). Upon receipt of the classification outputs, it may audibly or visually inform the user of their current cognitive state. In a more specific example, the networked device 2 may visually show a green colour on its GUI to inform that the user is in a positive cognitive state, and/or visually show a red colour on its GUI to inform that the user is in a negative cognitive state.

From hereon, one or more evaluations that were carried out to validate the performance of the bio-activity monitoring wearable 1 will be described. It is to be noted that parameters defined or determined in the evaluations are not meant to be interpreted as limitations to the scope of the invention.

FIG. 14 illustrates a first experiment procedure for validating the bio-activity monitoring wearable 1 of the present invention, which is an experimental procedure for the classification of BCI paradigms into the steady state visually evoked potential (SSVEP) category. Here, the bio-activity monitoring wearable 1 was worn by one or more participants. These participants were then instructed to remain still in a static manner, walked at one or more experiment assigned speeds (about 1.5 km/h, about 3.0 km/h, about 4.5 km/h and about 5.0 km/h on a treadmill (Xiaomi Kingsmith A1 WalkingPad Treadmill, with a resolution of 0.5 km/hr). Following each 10 min break, participant walked at one or more participant's selected own speeds (about 2.0 km/h, about 3.5 km/h and about 4.0 km/h). As each participant did so, they gazed at a monitor that displays four visual stimuli each with different flickering frequencies (about 6.0 Hz, about 6.67 Hz, about 7.5 Hz and about 8.57 Hz). At specified intermissions, the participant was instructed to focus on any one of the four visual stimuli. Biosignals of the participants were acquired, processed and transmitted by the bio-activity monitoring wearable 1 to the networked device 2 that preferably determined the accuracy of the classification. This was repeated around 12 runs per participant as shown in FIG. 14.

Results from the experimental procedure in FIG. 14 are shown in Table 1. Table 1 shows the cross-subject classification accuracy, trained on experiment assigned speeds, of the bio-activity monitoring wearable 1 across 8 participants during their runs in the experimental procedure.

TABLE 1

| | Assigned | | | | | User Selected | | |
|---|---|---|---|---|---|---|---|---|
| | Speed (km/hr) | | | | | Speed (km/hr) | | |
| Participant | 0 | 1.5 | 3 | 4.5 | 5 | 2 | 3.5 | 4 |
| 1 | 0.95 | 0.90 | 0.90 | 0.48 | 0.58 | 0.95 | 0.75 | |
| 2 | 0.85 | 0.80 | 0.55 | | | 0.75* | | |
| 3 | 0.70 | 0.85 | 0.75 | 0.43 | 0.65 | | 0.60 | 0.70 |
| 4 | 1.00 | 0.95 | 1.00 | 0.83 | 0.90 | | 0.90 | 0.85 |
| 5 | 0.88 | 0.98 | 0.95 | 0.84 | 0.76 | 1.00* | | |
| 6 | 1.00 | 1.00 | 1.00 | 0.95 | 1.00 | | | 0.98* |
| 7 | 1.00 | 1.00 | 0.98 | 0.80 | 0.80 | 1.00 | 1.00 | |
| 8 | 0.95 | 0.88 | 0.85 | 0.88 | 0.85 | 0.95 | 0.90 | |
| Average | 0.92 | 0.92 | 0.87 | 0.74 | 0.79 | 0.91 | 0.84 | 0.88 |

As shown in Table 1, the bio-activity monitoring wearable 1 is capable of classifying BCI paradigms across all speeds, even at speeds not specifically trained for.

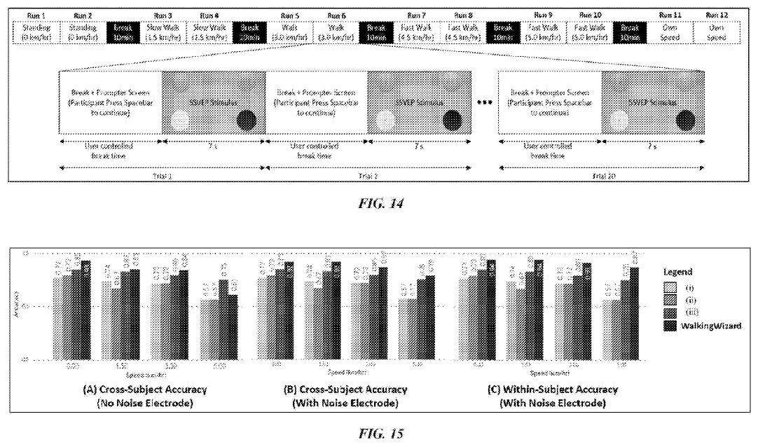

Furthermore, the bio-activity monitoring wearable 1 was further evaluated against other types of bio-activity monitoring wearables. FIG. 15 illustrates a cross-subject accuracy performance of the bio-activity monitoring wearable 1 of the present invention against bio-activity monitoring wearables of the prior art, more specifically from:
(i) Y.-P. Lin et al., “Assessing the feasibility of online SSVEP decoding in human walking using a consumer EEG headset”, Journal of Neuroengineering and Rehabilitation 2014;
(ii) Y.-P. Lin, Y. Wang et al., “A mobile SSVEP-based brain-computer interface for freely moving humans: The robustness of canonical correlation analysis to motion artifacts,” 2013 35th Annual International Conference of the IEEE EMBC, July 2013; and
(iii) Y.-P. Lin et al., “Assessing the quality of steady-state visual-evoked potentials for moving humans using a mobile electroencephalogram headset,” Frontiers in Human Neuroscience, March 2014.

As shown in FIG. 15, the bio-activity monitoring wearable 1 outperformed all other prior art, achieving a high 87% within-subject classification accuracy at 5.0 km/h.

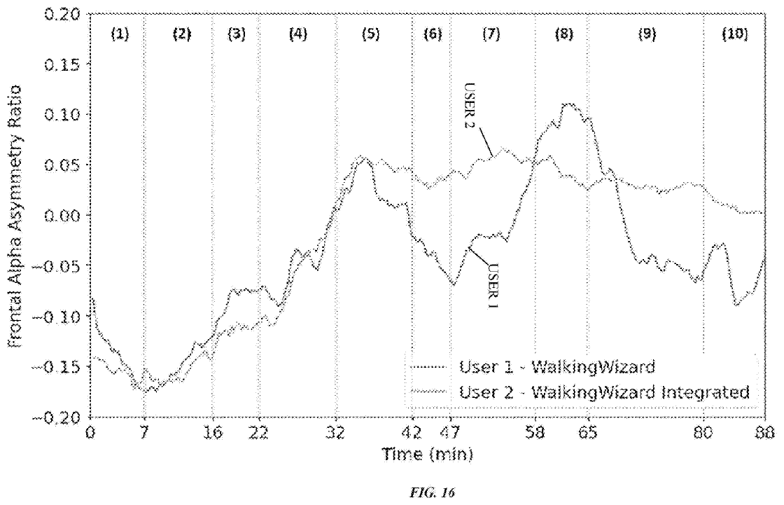

FIG. 16 illustrates two plots of frontal alpha asymmetry (FAA) ratio against time that were collected by the bio-activity monitoring wearable 1 in a second experiment procedure to validate SSVEP biosensing, whereby the bio-activity monitoring wearable 1 is configured to acquire, process, and classify biosignals based on their frontal alpha asymmetry (FAA) ratios.

Preferably, the bio-activity monitoring wearable 1 used for the second experimental procedure is an embodiment whereby there are two bio-information acquisition devices 12a of the first embodiment on the wearable device 11 that are in contact with the left and right hemispheres of the head of the user, as shown in FIG. 12. More specifically, there is a first bio-information acquisition device 12a of the first embodiment in contact with the F4 region, the F8 region, and the AF8 region on the right-hand side of the head of the participant, and there is a second bio-information acquisition device 12a of the first embodiment in contact with the F3 region, the F7 region, and the AF7 region on the left-hand side of the head of the participant. Furthermore, there is a bio-information acquisition device 12b of the second embodiment on the wearable device 11 includes a reference electrode that is in contact with the pre-frontal midline sagittal plane of the head of the user (FPz region). Furthermore, the conductive strip on the wearable device 11 is to act as a ground electrode and it is to be in contact with the FPz region of the head of the user as well.

In the second experiment procedure, two participants wearing the bio-activity monitoring wearable 1 were made to journey across a distance of 8.1 km, 5 km by cycling and 3.1 km by walking. A white background on the plot of FIG. 16 indicates the situation where the participant is walking, while a shaded background on the plot of FIG. 16 indicates the situation where the participant is riding the bicycle. User 1 or participant donned the bio-activity monitoring wearable 1 with electrodes at the F4,F6,AF8; F3,F7,AF7 positions as described in paragraph [00143]. User 2 or participant donned the bio-activity monitoring wearable 1 with electrodes at the FP1 and FP2 positions.

Accordingly, a positive gradient along the plot indicates that the participant is currently experiencing a positive cognitive state (i.e. becoming more approachable, becoming more relaxed, experiencing something that they like, etc.), whereas a negative gradient indicates the participant is currently experiencing a negative cognitive state (i.e. becoming more withdrawn, becoming more stressed, experiencing something that they dislike, etc.). The plot of FIG. 16 further indicates that the plot fluctuates with cognitive states according the environment experienced by the participant during their journey. By way of a subject example, in interval 6, there was a decrease in the FAA index of the participant as the participant had attempted to transverse across a bumpy pathway on their bicycle, indicating that the participant was currently experiencing a negative cognitive state as they became worried or afraid of falling off the bicycle during this interval; in contrast, in interval 7, participant walking in a serene park beside a reservoir experienced positive cognitive states as shown by a positive FAA index. A networked device 2 in connection with bio-activity monitoring wearable 1 may visually show a green colour on its GUI to inform that the user is in a positive cognitive state, and/or visually show a red colour on its GUI to inform that the user is in a negative cognitive state.

With this, the details pertaining to a bio-activity monitoring wearable 1 that performs acquisition, processing, calculation, and classification of biosignals, along with its corresponding system and method of use have been elucidated. Whilst bio-activity monitoring of the wearable 1 has been described to be primarily compatible with biosignals related to electroencephalography, it is to be noted that it may be readily generalised by a person skilled in the art for usage in electrocardiography electromyography, electrooculography, electrogastrography, or the like. The bio-information acquisition device 12a,12b, being capable of constant conformal contact with the user, further contributes to allowing the bio-activity of the user to be monitored even as the user is in motion.

In the above, the bio-information acquisition device has been described to be made up of two devices 12a, 12b. In another embodiment, the bio-information acquisition device is made up of a single flexible electronic board that is located inside the bio-activity monitoring wearable 1, for example, in an inside surface of the wearable cap, and is suitable for use as an EEG headset; in this EEG headset, the flexible electronic board is provided with multiple protrusions 122 that contact both the left and right hemispheres of the head of a user.

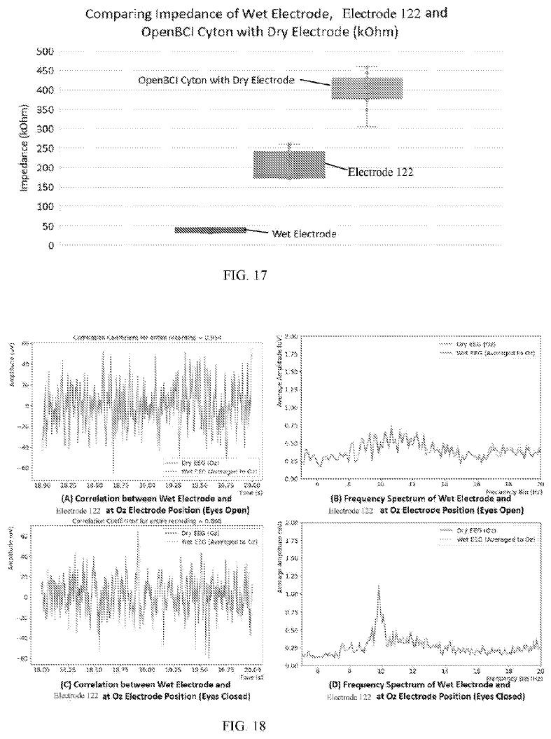

Further evaluations of the protrusions/electrodes 122 performance were made against known wet and dry electrodes. For example, the bio-information acquisition device of the present invention was used to record the EEG signals at the Oz, O1 and O2 electrode positions. Two wet electrodes constituting a gold standard for EEG recording signals were used to record the EEG signal at the electrode positions between Oz-O1 and Oz-O2 respectively, using “Ten20 Conductive Electrode Paste” obtainable from Weaver. A set of 12 impedance measurement was recorded once every minute; for the wet electrode without skin preparation, the electrode-skin impedance (25 to 75 percentile) ranged from about 31 to 45 kΩ. For the dry protrusions/electrodes 122 of the present invention, the impedance ranged from about 174kΩ to 231kΩ. The impedance measurement for the dry protrusions/electrodes 122 were high compared to that for the wet electrode but lower than OpenBCI Cyton dry electrodes, as shown in FIG. 17. As seen from FIG. 17, the protrusions/electrodes 122 exhibited electrode-scalp impedance of in the range of 200kΩ due to the absence of conductive gel, but the combed structure of the electrodes 122 provided effective hair penetration and significantly improved the electrode-scalp contact.

Alpha Rhythm capture performance of the electrodes 122 compared with the wet electrodes (constituting the gold standard for EEG) were recorded at the Oz electrode positions. One minute of EEG recording was performed on two users with both eyes opened, and another one minute each with both eyes closed. An arithmetic mean was obtained from results at the two wet EEG electrodes measured at Oz. Bandpass filter were set to 5 Hz to 30 Hz, amplitude and spectrum plots of the EEG recording at the Oz electrodes were obtained; Pearsons correlation was used to calculate the correlation between the EEG recordings at the electrodes 122 and the wet electrodes, when both the eyes are opened and closed; the correlation against the gold standard using known wet electrodes was about 95% and 87% for eyes opened and eyes closed, respectively, meaning performances of the electrodes 122 were comparable with those of the wet electrodes.

Further performance of the electrodes 122 against known dry EEG electrodes were made. These dry EEG electrodes with their sampling rate are shown in Table II below. In addition, digital bandpass filter of about 5 Hz to 30 Hz and notch filter at 50 Hz were performed on all the recorded signal.

TABLE II
provides a list of known dry EEG electrodes, labelled B-F
together with their signal sampling rates:

| Label | Dry EEG Electrodes | Sampling Rate |
|---|---|---|
| A | Electrodes 122 of present invention | 250 Hz |
| B | Emotiv Insight 2 | 128 Hz |
| C | Gtec gNAUTILUS with gSAHARA | 250 Hz |
| | electrodes | |
| D | OpenBCI Cyton with dry electrodes | 250 Hz |
| | from OpenBCI | |
| E | Emotiv MN8 | 128 Hz |
| F | OpenBCI Cyton with ThinkPulse | 250 Hz |
| | active electrodes | |

Emotiv Insight 2 and Emotiv MN8 did not provide impedance measurement. Instead, they denoted the quality of the electrode contact using red, orange and green; contact quality of green was obtained in these evaluations. gNAUTILUS also did not provide impedance measurement when interfaced with gSAHARA electrode, but contact impedance was estimated to be about 208kΩ. From FIG. 17, the impedance of OpenBCI Cyton with dry electrode ranged from about 375kΩ to 434kΩ, which were higher than about 174Ω to 231kΩ for the electrodes 122 of the present invention.

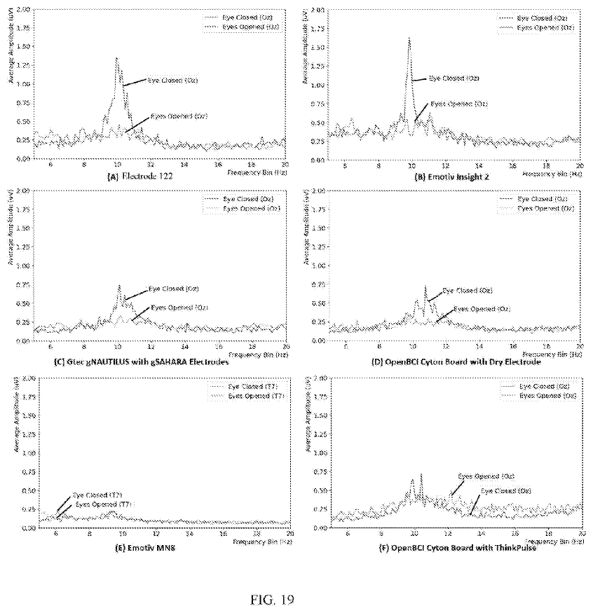

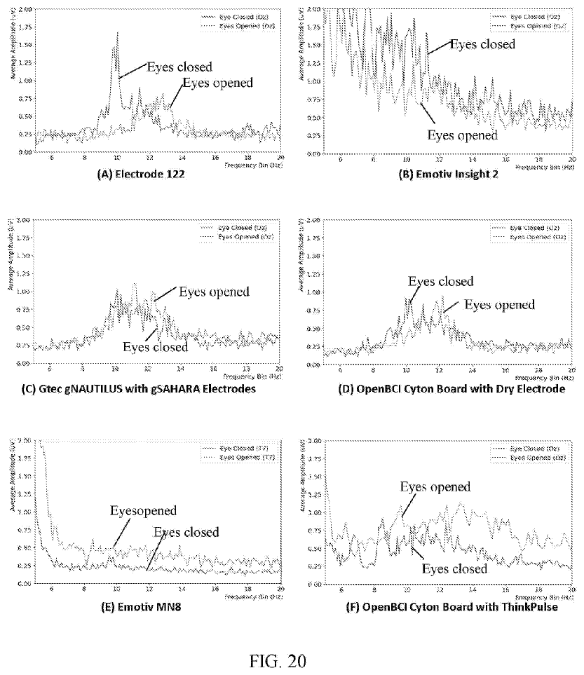

Alpha Rhythm Capture performance of the electrodes 122 compared with the above dry electrodes were recorded at the Oz electrode position. 2 users were recruited; for each user, one minute of EEG signal was recorded at the Oz electrode position when the user had both eyes opened, as well as both eyes closed, in a static scenario, that is, without motion or noise artifacts. Evaluations were then recorded with an idling vehicle (with engine turned on) with vibration inducing motion or noise artifacts on the EEG recording, as shown in FIGS. 20A-20F. The vehicle used in the experiment was a Nissan Cabstar and idling at about 500 RPM. From plot of the EEG recordings in FIG. 20A, it is clear that the dry electrodes 122 are suited to capture the EEG data; the high amounts of noise artifact that have been induced in the EEG recordings of the other five dry electrodes B-F result in the alpha rhythm signals being lost in the respective spectrum plots, as seen in FIGS. 20B-20F. The comparative EEG recordings in FIGS. 19A and 20A show that the noise-ground plane 1211 and the cleaning module 211 of the present invention are reliably configured.

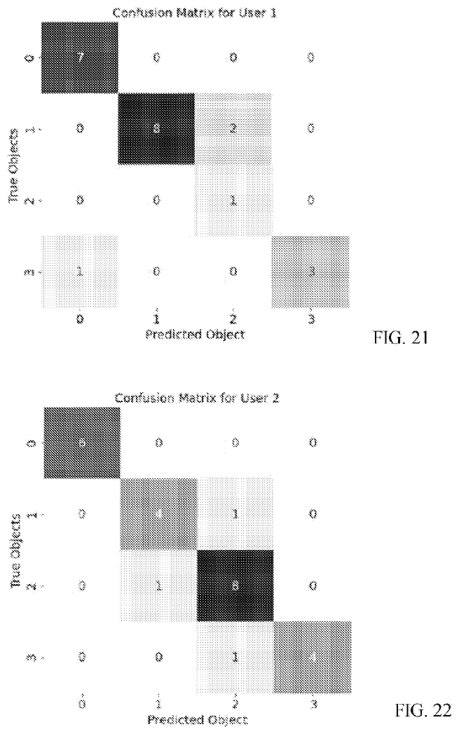

Further EEG signal capture experiments were conducted under different test environments. For example, the above the bio-information acquisition device being integrated with a single flexible electronic board was configured into an Oculus Quest 2 headset for simulating a virtual reality (VR) environment. Experiments were carried out according to the protocol shown in FIG. 14. As part of the VR experiment, each user was prompted to gaze at a confusion matrix made up of 4 flickering objects, shown in FIGS. 21 and 22 once every predetermined time period (such as every 7s). By randomly selecting a flickering object and responding to the object number, the response was recorded as a true output. Before responding to the object number, a predicted response was recorded from the electrode 122. A second user performed the same experiment but with an EEGNet training model after being fine-tuned. Accuracy of performance for the two users are 86% and 88%, respectively, meaning the EEG signals captured by the electrodes 122 in a VR environment were reasonable reliable.

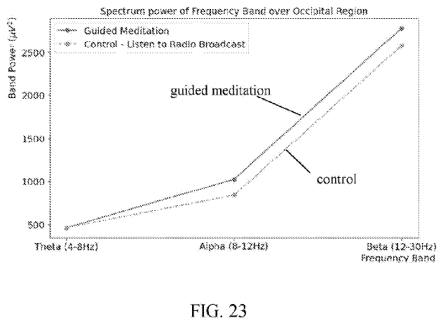

In another test environment, a user listened to a standard radio broadcast (such as, BBC World Service) for a duration of 12 min, seated with both eyes closed, and used as a control experiment; the user was then provided with a guided meditation podcast. The aim was to emulate an everyday passive listening scenario, where the cognitive state remains relatively constant; such guided meditation was designed to elicit deeper states of relaxation, focus and mindfulness. EEG recordings from the electrodes 122 were retrieved using a brainflow python library, obtained from: https://github.com/brainflow-dev/brainflow. Digital bandpass filterings of substantially 2 Hz to 30 Hz were performed on the EEG recordings and brain wave powers of these respective bands-Theta (4-8 Hz), Alpha (8-12 Hz) and Beta (12-30 Hz) were obtained, as shown in FIG. 23. With the user's eyes closed, high alpha wave was seen in both EEG recordings. Under guided meditation, the band power of the alpha wave was significantly higher, and for longer duration than in the control condition; these results provide objective evidence that guided meditation improved relaxation for the user.

From the above experimental evaluations, use of the above bioactivity monitoring device, wearable device or bioactivity monitoring device integrated with a VR headset, providing continuously sensing of a person's cognitive state as one goes about one's everyday life will enable many brain-computer interface (BCI) transformative applications. The bioactivity monitoring device of the present invention allows a quantitative measure of a person's cognitive or emotive state (stress/relax, likes/dislikes, emotions) which can be correlated with one's environment, objects or interactions with others. For example, therapists can use EEG signals to assess the impact of behavioural interventions for wellness program (such as, park prescriptions), marketers can use them to fine-tune responses to advertisements, dating agencies/applications can use them to improve their matches, and so on. The bioactivity monitoring device also provides a new mode of BCI control for a person to convey his/her intent—to a device, or to another person via such EEG signals; for example, cyclists could switch music tracks without getting their hands off the handle, paramedics could update on the status of the patient while still attending to the patient, and tactical law-enforcement officers could stealthily synchronize their assault weapons without any observable hand movements.

The present disclosure includes as contained in the appended claims, as well as that of the foregoing description. Although this invention has been described in its preferred form with a degree of particularity, it is understood that the present disclosure of the preferred form has been made only by way of examples and that numerous changes in the details of construction, the combination and arrangements of parts may be resorted to without departing from the scope of the present invention.

1. A bio-activity monitoring wearable, comprising:
a wearable device; and
at least one bio-information acquisition device attached to the wearable device;
wherein the bio-information acquisition device is in conformal contact as the wearable device is worn by the user.

2. The bio-activity monitoring wearable according to item claim 1, wherein the bio-information acquisition device further comprises:
an electronic board; and
a plurality of projections.

3. The bio-activity monitoring wearable according to claim 2, wherein the plurality of projections forms at least one projection cluster on the electronic board.

4. The bio-activity monitoring wearable according to claim 2 or 3, wherein the electronic board is pliable.

5. The bio-activity monitoring wearable according to claim 2, wherein the electronic board comprises one or more layers that comprise a noise-ground plane layer.

6. The bio-activity monitoring wearable according to claim 2, wherein the projections are elastic.

7. The bio-activity monitoring wearable according to claim 2, wherein the projections are in contact with skin of the user, as the wearable device is worn by the user, even as the user is in motion.

8. The bio-activity monitoring wearable according to claim 2, wherein the projections further comprise a resilient member.

9. The bio-activity monitoring wearable according to claim 3, wherein the projections in the projection cluster have a comb-like arrangement.

10. The bio-activity monitoring wearable according to claim 1, further comprising a conditioning module, a digitization and communication device and a networked device.

11. The bio-activity monitoring wearable according to claim 10, wherein the networked device operates a cleaning module.

12. The bio-activity monitoring wearable according to claim 10, wherein the networked device operates an augmentation module.

13. The bio-activity monitoring wearable according to claim 10, wherein the networked device operates a calculation module.

14. The bio-activity monitoring wearable according to claim 10, wherein the networked device operates a classification module.

15. The bio-activity monitoring wearable according to claim 14, wherein the classification module classifies inputs into one or more categories across the brain-computer interface paradigm as outputs.

16. The bio-activity monitoring wearable according to claim 1, further comprising a conductive strip to act as a ground electrode.

17. The bio-activity monitoring wearable according to claim 1, wherein the wearable device is configured as a cap.

18. A system for monitoring bio-activity of a user, comprising:
a bio-activity monitoring wearable, that comprises:
a wearable device;
at least one bio-information acquisition device attached to the wearable device; and
a networked device in connection with the bio-activity monitoring wearable device;
wherein the bio-information acquisition device of the bio-activity monitoring wearable is in conformal contact with the user as the wearable device is worn by the user.

19. A method for capturing electroencephalography (EEG) bio-activity of a user comprises:
wearing, by a user, a bio-activity monitoring wearable, comprising:
a wearable device; and
at least one bio-information acquisition device attached to the wearable device;
wherein the bio-information acquisition device is in conformal contact with the user as the wearable device is worn by the user.

20. The method of claim 19, further comprising:
tapping on the EEG signal to assess a user's cognitive or emotive state or behavioural response to a stimulus.

21. The method of claim 19, further comprising tapping on the EEG signal to provide a signal to activate or control an external device or an application.
